(19) United States
(12) Patent Application Publication
(10) Pub. No.: US 2024/0013196 A1
(43) Pub. Date: Jan. 11, 2024

(54) SYSTEMS AND METHODS TO GENERATE A COMPOSITE REPRESENTATION OF A DIGITAL WALLET BASED ON DIGITAL ASSETS INDICATED BY THE DIGITAL WALLET

(71) Applicant: Disney Enterprises, Inc., Burbank, CA (US)

(72) Inventors: Alif Khalfan, Redwood City, CA (US); Brianna Cochran, Burbank, CA (US); Zachary Shalett, Los Angeles, CA (US); Benjamin Lopez Barba, Burbank, CA (US); Malcolm E. Murdock, Burbank, CA (US)

(21) Appl. No.: 18/347,291

(22) Filed: Jul. 5, 2023

Related U.S. Application Data
(60) Provisional application No. 63/359,152, filed on Jul. 7, 2022.

(51) Int. Cl. G06Q 20/36

(52) U.S. Cl. CPC G06Q 20/36

(57) ABSTRACT

Systems and methods to generate a composite representation of a digital wallet based on digital assets indicated by the digital wallet are disclosed. Exemplary implementations may: determine a set of digital assets indicated as owned by digital wallets; determine, based on the set of digital assets, the correlated entities; analyze the correlated entities to determine a composite representation of the entities or adjustments to the composite representation; mint a composite digital asset correlated with the composite representation; and update, upon determination of the adjustments to the composite representation, the composite representation in accordance with the adjustments.

### CROSS-REFERENCE TO RELATED APPLICATIONS

The present application claims priority benefit of the U.S. Provisional Patent Application No. 63/359,152 titled “SYSTEMS AND METHODS TO GENERATE A COMPOSITION REPRESENTATION OF A DIGITAL WALLET BASED ON DIGITAL ASSETS INDICATED BY THE DIGITAL WALLET” filed on Jul. 7, 2022, the contents of which are incorporated herein by reference in their entirety. The subject matter of this related application is hereby incorporated herein by reference.

### FIELD OF THE DISCLOSURE

The present disclosure relates to systems and methods to generate a composite representation of a digital wallet based on digital assets indicated by the digital wallet.

### BACKGROUND

Individual users may collect multiple digital assets that are correlated to entities. Some or all of the correlated entities may be related and collectively represent interests, preferences, and/or a personality of the individual users.

### SUMMARY

One aspect of the present disclosure relates to a system configured to generate a composite representation of a digital wallet based on digital assets held by the digital wallet. The digital wallet, associated with a user, may indicate a set of digital assets that the user owns. Individual ones of the digital assets may be correlated with entities such as content, physical articles, among others. Upon determination of the entities based on the correlated digital assets, the entities may be analyzed to determine a composite representation or adjustments to the composite representation. The composite representation may collectively represent all the entities correlated to all the digital assets in the digital wallet whether digital assets are newly added or newly removed. Upon the determination of the composite representation, a composite digital asset may be minted and correlated with the composite representation. As such, ownership of the composite digital asset may be established and recorded on a decentralized ledger where changes in the ownership may be enabled via transactions recorded on the decentralized ledger. Upon the determination of the adjustments to the composite representation, the composite representation may be updated in accordance with the adjustments.

Thus, a system that generates composite representations of digital wallets of users and establishes individual digital assets that are correlated with the composite representations in a decentralized manner amongst a plurality of distributing computing platforms is provided. A decentralized manner of performing such limitations may ensure that one set of servers does not burden performing all the limitations for a plurality of digital wallets and risk overwhelming the set of servers. The system may further enable and facilitate increased recordation of ownership of digital assets that are correlated with a unique entities that individually represent unique combinations of entities as the system provides individual users a simplified manner to do so. The decentralized manner may additionally ensure that the ownership of the digital assets is not easily mutable unless modified via instructions that are implemented by the distributed computing platforms. Furthermore, the individual composite digital assets may be utilized at various locations and/or on various online platforms to provide the users with unique experiences based on their composite digital assets (and the correlated composite representations) in addition to being displayed for the users (e.g., as a profile picture, on a Smartwatch, on a Smart badge).

The system may include one or more hardware processors configured by machine-readable instructions. The machine-readable instructions may include one or more instruction components. The instruction components may include computer program components. The instruction components may include one or more of set determination component, entity determination component, entity analysis component, asset minting component, update component, and/or other instruction components.

The set determination component may be configured to determine a set of digital assets held in a digital wallet associated with a user. The digital assets may be correlated with entities. Digital wallets may correspond to addresses on a decentralized ledger.

The entity determination component may be configured to determine, based on the set of digital assets, the correlated entities.

The entity analysis component may be configured to analyze the correlated entities to determine a composite representation of the entities or adjustments to the composite representation.

The asset minting component may be configured to mint a composite digital asset correlated with the composite representation.

The update component may be configured to update, upon determination of the adjustments to the composite representation, the composite representation in accordance with the adjustments.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to generate a composite representation of a digital wallet based on digital assets indicated by the digital wallet, in accordance with one or more implementations.

FIG. 2 illustrates a method to generate a composite representation of a digital wallet based on digital assets indicated by the digital wallet, in accordance with one or more implementations.

FIG. 3 illustrates an example of the system configured to generate a composite representation of a digital wallet based on digital assets indicated by the digital wallet, in accordance with one or more implementations.

### DETAILED DESCRIPTION

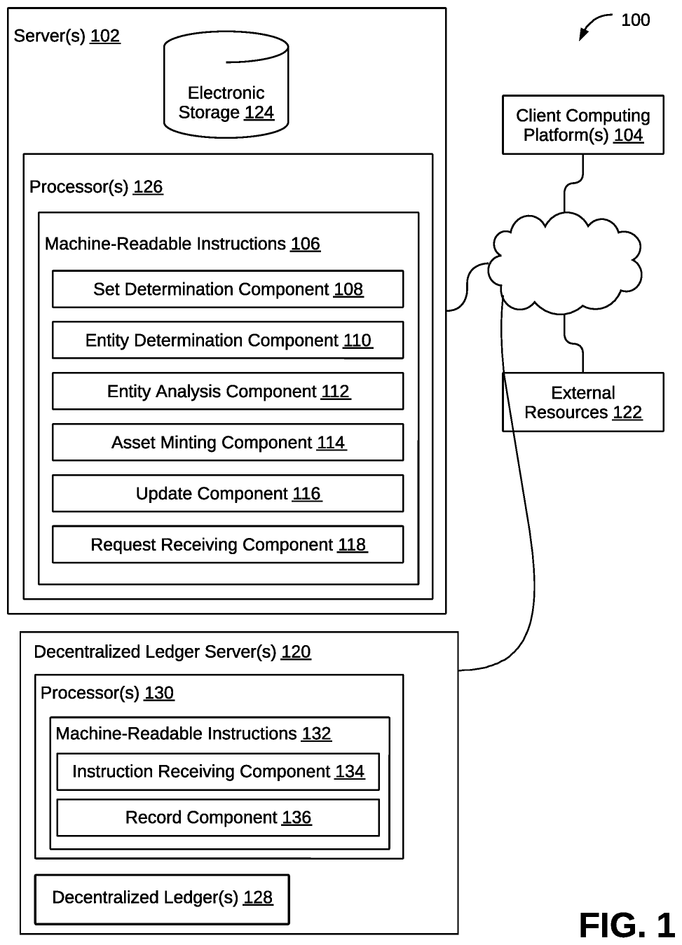

FIG. 1 illustrates a system 100 configured to generate a composite representation of a digital wallet based on digital assets indicated by the digital wallet, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

As used herein, the term “digital asset” may refer to a unique identifier tracked on one or more permanent registries. The digital assets may be uniquely identified and/or uniquely identifiable. The unique identifier may include a set of numbers and/or alphabetic characters. As used herein, rights pertaining to digital assets may be tracked, recorded, and/or otherwise registered on one or more permanent registries. As such, an individual digital asset may be a registry-tracked digital asset.

Individual digital assets may be associated and/or correlated with another entity (which may be referred to as a “correlated entity”) by virtue of technology provided and/or supported by the one or more permanent registries on which the rights pertaining to the individual digital assets is tracked (including but not limited to smart contracts and/or other executable code on the one or more permanent registries). Accordingly, rights pertaining to a digital asset may correlate to the provision of one or more rights with respect to the correlated entity (e.g., control of the correlated entity and/or accessibility to the correlated entity). Transactions involving a digital asset recorded on a permanent registry may correlate to certain transactions (or modifications) of the correlated entity, and/or vice versa.

Various types and/or combinations of correlated entities are envisioned within the scope of this disclosure, including but not limited to physical article, virtual objects, content, rights, memberships, grants, etc. The use of the singular “entity” or “correlated entity” is not intended to be limiting, as multiple different objects, content, rights, memberships, grants, etc. may be correlated to a single digital asset. By way of non-limiting example, a correlated entity may be a physical article (e.g., artwork, a ticket to an event), a subscription to certain media content, content and so forth. The content may include an image, a video, a graphic image file, a signature of notoriety, a sound bite of an audio file, text, the audio file, and/or other content stored on the decentralized ledger and/or other electronic storage. In some implementations, the correlated entity may refer to any physical articles, virtual objects, content, rights, memberships, grants, etc. object related to art and entertainment for which a user may use, own, sell, trade, loan, destroy, and/or otherwise effectuate a change of ownership, access, or control (including exchanges through challenges).

A digital asset may be fungible if it is functionally and/or physically indistinguishable from another digital asset. A digital asset may be non-fungible if it is unique, or one-of-a-kind. For example, a specific individual may be non-fungible. A digital asset may be semi-fungible if there is a set of a limited number of similar but distinguishable digital assets. For example, a limited amount of images of sports team for a particular year may be semi-fungible. For example, a digital ticket to a show, concert, exhibition, and/or other event may be semi-fungible. The semi-fungible digital assets are considered as unique, “not fungible”, or non-fungible digital assets. In some implementations, the digital assets may include non-fungible tokens, fungible tokens, semi-fungible tokens, and/or other digital assets.

In some implementations, permanent registries, or decentralized ledger(s) 128, may be implemented by registry servers or decentralized ledger server(s) 120. The terms “permanent registries” and “decentralized ledgers” may be used interchangeably herein. The terms “registry servers” and “decentralized database servers” may be used interchangeably herein. In some implementations, one or more permanent registries may be decentralized and/or immutable registries. In some implementations, the one or more permanent registries may be one or more databases on which the rights pertaining to the individual digital assets are tracked and/or recorded. In some implementations, blockchains may be maintained by distributed computing platforms (not shown in FIG. 1). In some implementations, a distributed computing platform may be implemented by a set of client computing platforms and/or servers (including, for example, one or more registry servers). The distributed computing platform may support a virtual machine (not shown in FIG. 1). The distributed computing platform and/or the virtual machine may form a runtime environment for smart contracts and/or other executable code. A distributed computing platform may include electronic storage configured to store part or all of individual blockchains. For example, the smart contracts may be stored on one or more blockchains, and/or another permanent registry. In some implementations, the distributed computing platform may be the EOSIO platform. In some implementations, the distributed computing platform may be similar to or based on the EOSIO platform. In some implementations, the distributed computing platform may be Ethereum. In some implementations, the distributed computing platform may be similar to or based on Ethereum. In some implementations, the virtual machine may be a distributed and/or decentralized virtual machine.

In some implementations, at least one of the permanent registries may be a private permissioned permanent registry (e.g., a private permissioned blockchain). The private permissioned permanent registry may be configured to record information and/or track addresses (e.g., corresponding to digital wallets, smart contracts, etc.). The recorded information may include rights pertaining to the digital assets. For example, ownership rights and/or other accessibility may be modified. In some implementations, the ownership rights and/or other rights may be indicated by addresses that correspond to digital wallets of users tracked and recorded by the permanent registries on the registry servers and transaction information recorded on the permanent registries. In some implementations, a digital asset may be removed from one permanent registry and added or recorded on another permanent registry. In some implementations, at least one of the permanent registries implemented by the registry servers is a public permanent registry (e.g., a public blockchain). The public permanent registry may be configured to be part of either EOSIO mainnet, Ethereum mainnet, Ethereum 1.5, Ethereum 2.0, a derivative of Ethereum 2.0 that is configured to perform transactions of Ether (ETH) between accounts, or a derivative of EOSIO that is configured to perform transactions of EOS between different accounts.

Elements of a blockchain or another permanent registry may be grouped together in units that are referred to as blocks. For example, an individual block may include one or more digital assets and one or more transactions. For example, an individual block may be linked to one or more other individual blocks. Individual blocks may be linked or chained together to form a structure of blocks and/or a hierarchy of blocks, such as, e.g., a chain of blocks. An individual block may include one or more digital assets, one or more transactions, smart contracts, and/or other information.

In some implementations, one or more permanent registries implemented by the registry servers may be publicly accessible. In some implementations, for example, the one or more databases may be accessible via a mobile application or a website. In some implementations, one or more permanent registries implemented by the registry servers may be private and/or permissioned. In some implementations, one or more permanent registries implemented by the registry servers may be append-only. In some implementations, existing blocks of one or more permanent registries implemented by the registry servers can substantially not be altered or deleted, unless multiple copies are altered. This is unlikely to happen provided that the multiple copies are stored on different computing platforms, e.g., in different geographical locations. Permanent registries may be replicated on multiple computing platforms, preferably in multiple different geographical locations. Additionally, individual blocks may be linked together in a manner that prevents tampering, such as, e.g., using a hash chain and/or digital signatures. In particular, hash values may be generated using fixed-output-length one-way hashing functions that take variable-length input, and may be effectively impossible (or, at least, computationally infeasible) to reverse. As such, a hashing function may provide one-way encryption. By way of non-limiting example, the hashing function may be SHA-256, BLAKE2, SHAKE256, and/or another hashing function. Contents of individual blocks, transactions, and/or articles may be digitally signed in a manner that proves integrity and/or prevents tampering, e.g., by providing authentication, as well as non-repudiation.

The decentralized ledger server(s) 120 may include one or more of processor(s) 130, machine-readable instructions 132, decentralized ledger(s) 128, electronic storage (not illustrated), and/or other components. The electronic storage may be similar to electronic storage 124 as described elsewhere in this disclosure, though included in the decentralized ledger server(s) 120. Machine-readable instructions 132 may include one or more instruction components. The instruction components may include computer program components. The instruction components may include one or more of an instruction receiving component 134, a record component 136, and/or other instruction components. Processor(s) 130 may be similar to processor(s) 126 as described elsewhere in this disclosure, though included in the decentralized ledger server(s) 120. Machine-readable instructions 132 may be similar to machine-readable instructions 106 as described elsewhere in this disclosure, though included in decentralized ledger server(s) 120.

Instruction receiving component 134 may be configured to receive (sets of) instructions to add, modify, analyze, and/or remove recorded information (e.g., rights, transactions) in the decentralized ledger(s) 128. For example, instruction receiving component 134 may receive one or more sets of instructions from other components of system 100. Instruction receiving component 134 may provide received sets of instructions to the record component for execution. In some implementations, instruction receiving component 134 may be arranged, organized, and/or otherwise included in the decentralized ledger server(s) 120 and/or the decentralized ledger(s) 128.

Record component 136 may be configured to record information, including but not limited to ownership rights pertaining to the digital assets correlated with entitles, e.g., on one or more permanent ledgers such as decentralized ledger(s) 128. In some implementations, record component 136 may add, modify, analyze, and/or remove recorded information.

Server(s) 102 may be configured by machine-readable instructions 106. Machine-readable instructions 106 may include one or more instruction components. The instruction components may include computer program components. The instruction components may include one or more of set determination component 108, entity determination component 110, entity analysis component 112, asset minting component 114, update component 116, request receiving component 118, and/or other instruction components.

Set determination component 108 may be configured to determine individual sets of digital assets held in individual ones of the digital wallets and thus owned by individual ones of the users associated with the individual digital wallets. The digital wallets may correspond to particular addresses on decentralized ledger 128. The digital assets may be correlated with entities. By way of non-limiting example, the correlated entities may include a digital character, a digital tool, a digital media file, a digital location, a digital vehicle, collectible article, a signature, and/or other digital entities or physical entities. In some implementations, individual ones of the correlated entities may be associated with values to ability parameters, battle parameters, entity identity parameters, accomplishments, and/or other parameters. In some implementations, determining the set of digital assets, may be performed periodically. The term “periodically” may refer to performing an action (e.g., determine) recurringly instantaneously, every second, every minute, every day, every two days, every week, every month, and/or other amount of time.

The ability parameters may include a power, a speed, an accuracy, a stamina, a skill, a sport, and/or other ability parameters where values define the ability of a virtual character or a virtual object. The battle parameters may include a speed of recovery, tools for recovery, vulnerability to damage, hit points, skill points, strength, intelligence, agility, experience level, and/or other battle parameters.

The entity identity parameters may include a name, an entity type, a content universe, a character class, a character, species, a personality, and/or other entity identity parameters. By way of non-limiting example, values to the entity type may include a tool, a playing card, a vehicle, a character, a pet, and/or other values. The value to the content universe may refer to a collection characters, movies, television shows, and/or games. The various content universes may include different ones of the species, the character classes, environments, and/or other features. The accomplishments may include trick shots, speed records, distance records, championships, points per game, special item obtainment, views, likes, re-shares, and/or other accomplishments. The parameters described herein are for illustrative purposes and are not intended to be limiting with regard to what defines the correlated entities.

Entity determination component 110 may be configured to determine, based on the sets of digital assets, the correlated entities. In some implementations, electronic storage 124 and/or other electronic storage may be configured to store the correlated entities. In some implementations, determining the correlated entities may include accessing electronic storage 124 and/or other electronic storage via a link recorded on decentralized ledger 128 with the digital assets, identifying a serial number and/or model of physical articles based on the digital asset in electronic storage 124 and/or other electronic storage, analyzing decentralized ledger 128 given that the correlated entities are recorded on decentralized ledger 128, and/or other determinations. Given that the users may obtain and relinquish one or more of the digital assets held in their digital wallets, determining the correlated entities may be performed periodically.

Entity analysis component 112 may be configured to analyze the correlated entities, that are correlated to the sets of digital assets, to determine individual composite representations of the correlated entities or adjustments to the individual composite representations. Analyzing the correlated entities may include analyzing the associated values to the ability parameters, the battle parameters, the entity identity parameters, the accomplishments, and/or other parameters. In some implementations, different values to the individual parameters may cause a different visual feature of the individual composite representations. In some implementations, different combinations of different values to the individual parameters may cause a different visual feature of the individual composite representations. Analyzing the correlated entities may be performed periodically. A composite representation may include a visual symbol that summarizes the correlated entities into one visual entity. In some implementations, the composite representation may include the values to the ability parameters, the battle parameters, the entity identity parameters, the accomplishments, and/or other parameters that the visual symbol is based on. The adjustments to the composite representation may include adjustments to the visual symbol. By way of non-limiting example, the visual symbol may include one of an image, a graphical image file, a short video, and/or other visual symbol. The visual symbol, and adjustments thereof, may include one or more colors, one or more fonts, one or more font sizes, one or more font colors, one or more attractions, one or more icons (e.g., celebrities, characters), one or more events, one or more consumables (e.g., food, beverages), and/or other visual features. The composite representation may be stored in electronic storage 124 and/or other electronic storage.

Asset minting component 114 may be configured to mint individual composite digital assets correlated with the individual composite representations. Minting the individual composite digital assets and correlating the individual composite digital assets to the individual composite representations may be responsive to determining the composite representation. As used herein, the word “mint” may refer to performance, initiating, and/or execution of the process(es), transaction(s), procedure(s), operation(s), and/or step(s) that result in the instantiation of a given digital asset, including the establishment of ownership, and definition of appearance of the given digital asset. Minting the given digital asset may include generating a given digital asset record for a given entity, e.g., the composite representation. In some implementations, minting the given digital asset may include building an executable program. The executable program to be transmitted to a distributed computing platform(s) capable of executing the program. In some implementations, execution of the program by the distributed computing platform(s) may display a given correlated composite representation with the values to the ability parameters, the character parameters, the recovery parameters, and/or other parameters defining the given composite representation on the distributed platform(s). In some implementations, the given digital asset record may include such values that define the given composite representation. In some implementations, the given digital asset record may be recorded at an address on decentralized ledger(s) 128, an address on decentralized ledger(s) 128 in a smart contract, on decentralized ledger(s) 128 in other executable code. The given digital asset record may include information pertaining to the minted digital asset, not limited to the values that define the given composite representation.

In some implementations, asset minting component 114 may be configured to generate one or more sets of instructions to record transaction information on decentralized ledger(s) 128 that specify the individual composite digital assets are sent to individual ones of the addresses that correspond to the digital wallets, execute the one or more set of instructions, and/or other functions. Executing the one or more sets of instructions may include transmitting the one or more sets of instructions to instruction receiving component 134. Subsequently, instruction receiving component 134 may receive the one or more sets of instructions, and recording component 136 may record the one or more sets of instructions on decentralized ledger(s) 128. The digital wallets may thus hold the composite digital assets correlated to the composite representations that represent the digital wallets themselves.

For example, a first set of digital assets may be determined given a first digital wallet that is associated with a first user. That is, the first user owns the first set of digital assets that are held in the first digital wallet. The first set of digital assets may be correlated with a first set of entities. The first set of correlated entities may be analyzed to determine a first composite representation that summarizes the first set of correlated entities into a first visual symbol. A first composite digital asset may be minted and correlated with the first composite representation. A first set of instructions may be generated to record first transaction information specifying that the first composite digital asset is sent to a first address (corresponding to the first digital wallet). Thus, the first digital wallet, by way of its corresponding first address, may hold the first digital asset correlated to the first composite representation that represents the first digital wallet itself.

Update component 116 may be configured to update, upon determination of the adjustments to the individual composite representations, the composite representations in accordance with the adjustments. The composite representations, that is the visual symbols, may be updated upon determination of the adjustments to the composite representations. Updating the composite representations may not require re-minting the composite digital assets that the composite representations are correlated to. Rather, given that the composite representations are stored in electronic storage 124 and/or other electronic storage, and correlated with the composite digital assets, the composite representations in electronic storage 124 and/or other electronic storage may be updated accordingly.

Request receiving component 118 may be configured to receive a request to export the individual composite representations and/or transmit the composite representations. In some implementations, the request may be received from one or more user accounts associated with the user and of online platforms to display the composite representation. The online platforms that the users may have one or more accounts with may be associated with an amusement park, an entertainment company, a music company, a sports league or company, a restaurant group, and/or other establishments. By way of non-limiting example, the composite representation may be displayed as a profile picture for a given account, on smart devices (e.g., smart badges, Smartwatches, Smartphones), sent via communication channels (e.g., text message, E-mail), and/or displayed in other manners.

Request receiving component 118 may be configured to provide the composite representation to the online platforms and in association with respective user accounts. In some implementations, providing the composite representations may include establishing communication connections between the online platforms and electronic storage 124 and/or other storage that the composite representations are stored in. The communication connections may include wireless communications, hardwire communication, Bluetooth communication, and/or other communications. In some implementations, providing the composite representation may include exporting a copy of the composite representation from electronic storage 124 and/or other storage and transmitting the copy to the user account requesting the composite representation.

The composite representation may facilitate in provide individualized units of experience for the users. The units of experience may include a ride attraction, a parade, a show, a virtual reality simulation, a character controlled by the user in a digital environment, a food item, a beverage item, or other unit of experience that may be personalized for the users based on the composite representations that represent their digital wallets. Individual units of experiences may be associated with a location area or a location path where the unit of experience occurs. The location area may be a particular square footage, a range of global positioning system (GPS) coordinates, an area in between boundaries (e.g., streets, ride attractions), or other location area. The location path may be between GPS coordinates, along a particular boundary, or other location path with a beginning and an end. The parade and the show may be units of experience that multiple users may attend at once in one location area or along one location path. For example, features of the parade may be based on the composite representation. The ride attraction may be a unit of experience that a single user or a set of users, e.g., 2-4 users, may experience at once. Colors and/or ingredients of the food item and the beverage item may be personalized based on the composite representation. Content presented within the virtual reality simulation and the characters controlled by the users in the digital environments may be personalized based on the composite representation.

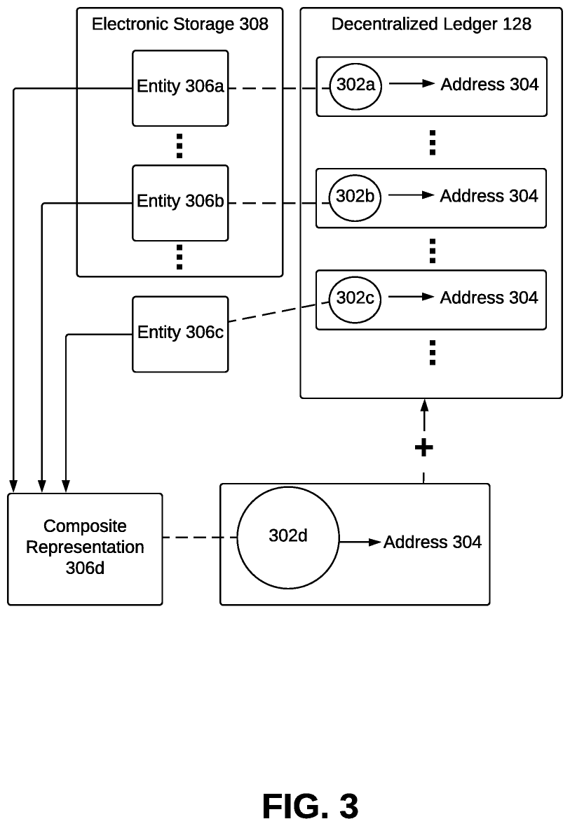

FIG. 3 illustrates decentralized ledger 128 (the same as or similar to FIG. 1) that has recorded digital assets 302a, 302b, and 302c at address 304. Address 304 may be associated with a digital wallet of a user such that digital assets may be indicated as owned by the user by way of their digital wallet. Digital assets 302a, 302b, and 302c may be correlated with entities 306a, 306b, and 306c, respectively. Entities 306a-b may be stored in electronic storage 308 (e.g., the same as electronic storage 124 in FIG. 1) and entity 306c may be a physical article (e.g., toy, clothing). Based on entities 306a-c, a composite representation 306d (i.e., an entity) may be generated. A composite digital asset 302d may be minted and correlated with composite representation 306d. Composite digital asset 302d may be sent to address 304, and thus the digital wallet of the user, and such transaction may be recorded on decentralized ledger 128.

Referring back to FIG. 1, in some implementations, server(s) 102, client computing platform(s) 104, and/or external resources 122 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 122 may be operatively linked via some other communication media.

A given client computing platform 104 may include one or more processors configured to execute computer program components. The computer program components may be configured to enable an expert or user associated with the given client computing platform 104 to interface with system 100 and/or external resources 122, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 122 may include sources of information outside of system 100, external entities participating with system 100, and/or other resources. In some implementations, some or all of the functionality attributed herein to external resources 122 may be provided by resources included in system 100.

Server(s) 102 may include electronic storage 124, one or more processors 126, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 124 may comprise non-transitory storage media that electronically stores information. The electronic storage media of electronic storage 124 of 25 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 124 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 124 may include one or more virtual storage resources (e.g., cloud storage, a virtual private network, and/or other virtual storage resources). Electronic storage 124 may store software algorithms, information determined by processor(s) 126, information received from server(s) 102, information received from client computing platform(s) 104, and/or other information that enables server(s) 102 to function as described herein.

Processor(s) 126 may be configured to provide information processing capabilities in server(s) 102. As such, processor(s) 126 may include one or more of a digital processor, an analog processor, a digital circuit designed to process information, an analog circuit designed to process information, a state machine, and/or other mechanisms for electronically processing information. Although processor(s) 126 is shown in FIG. 1 as a single entity, this is for illustrative purposes only. In some implementations, processor(s) 126 may include a plurality of processing units. These processing units may be physically located within the same device, or processor(s) 126 may represent processing functionality of a plurality of devices operating in coordination. Processor(s) 126 may be configured to execute components 108, 110, 112, 114, 116, and/or 118, and/or other components. Processor(s) 130 may be configured to execute components 134 and/or 136, and/or other components. Processor(s) 126 may be configured to execute components 108, 110, 112, 114, 116, and/or 118, and/or other components and processor(s) 130 may be configured to execute components 134 and/or 136, and/or other components by software; hardware; firmware; some combination of software, hardware, and/or firmware; and/or other mechanisms for configuring processing capabilities on processor(s) 126 and processor(s) 130, respectively. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, and/or 118 and components 134 and/or 136 are illustrated in FIG. 1 as being implemented within single separate processing units, in implementations in which processor(s) 126 and processor(s) 130 includes multiple processing units, one or more of components 108, 110, 112, 114, 116, and/or 118 may be implemented remotely from the other components and components 134 and/or 136 may be implemented remotely from the other components, respectively.

The description of the functionality provided by the different components 108, 110, 112, 114, 116, 118, 134, and/or 136 described below is for illustrative purposes, and is not intended to be limiting, as any of components 108, 110, 112, 114, 116, 118, 134, and/or 136 may provide more or less functionality than is described. For example, one or more of components 108, 110, 112, 114, 116, 118, 134, and/or 136 may be eliminated, and some or all of its functionality may be provided by other ones of components 108, 110, 112, 114, 116, 118, 134, and/or 136. As another example, processor(s) 126 and processor(s) 130 may be configured to individually execute one or more additional components that may perform some or all of the functionality attributed below to one of components 108, 110, 112, 114, 116, and/or 118, and one of components 134 and/or 136, respectively.

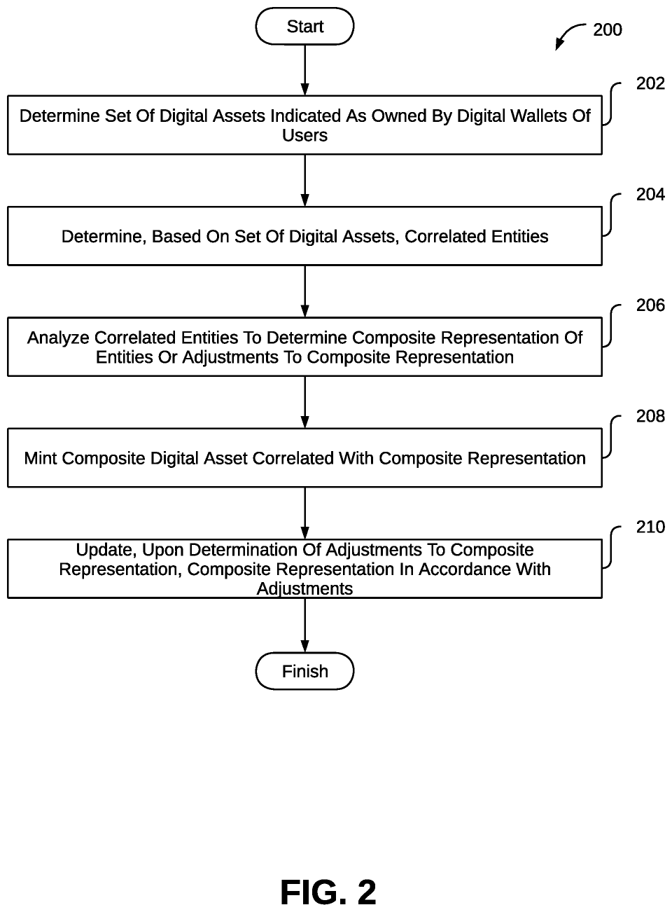

FIG. 2 illustrates a method 200 to generate a composite representation of a digital wallet based on digital assets indicated by the digital wallet, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include determining a set of digital assets indicated as owned by digital wallets. The digital assets may be correlated with entities. The digital wallets correspond to addresses on a decentralized ledger. Operation 202 may be performed by one or more hardware processors configured by machine-readable instructions including a component that is the same as or similar to set determination component 108, in accordance with one or more implementations.

An operation 204 may include determining, based on the set of digital assets, the correlated entities. Operation 204 may be performed by one or more hardware processors configured by machine-readable instructions including a component that is the same as or similar to entity determination component 110, in accordance with one or more implementations.

An operation 206 may include analyzing the correlated entities to determine a composite representation of the entities or adjustments to the composite representation. Operation 206 may be performed by one or more hardware processors configured by machine-readable instructions including a component that is the same as or similar to entity analysis component 112, in accordance with one or more implementations.

An operation 208 may include minting a composite digital asset correlated with the composite representation. Operation 208 may be performed by one or more hardware processors configured by machine-readable instructions including a component that is the same as or similar to asset minting component 114, in accordance with one or more implementations.

An operation 210 may include updating, upon determination of the adjustments to the composite representation, the composite representation in accordance with the adjustments. Operation 210 may be performed by one or more hardware processors configured by machine-readable instructions including a component that is the same as or similar to update component 116, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to generate a composite representation of a digital wallet based on digital assets indicated by the digital wallet, the system comprising:
one or more processors configured by machine-readable instructions to:
determine a set of digital assets held in a digital wallet associated with a user, wherein the digital assets are correlated with entities, wherein digital wallets correspond to addresses on a decentralized ledger;
determine, based on the set of digital assets, the correlated entities;
analyze the correlated entities to determine a composite representation of the entities or adjustments to the composite representation;
mint a composite digital asset correlated with the composite representation; and
update, upon determination of the adjustments to the composite representation, the composite representation in accordance with the adjustments.

2. The system of claim 1, wherein the entities include a digital character, a digital tool, a digital media file, a digital location, and/or a digital vehicle, wherein individual ones of the entities are associated with values to ability parameters, battle parameters, entity identity parameters, and/or accomplishments.

3. The system of claim 2, wherein the composite representation includes a visual symbol and values to the ability parameters, the battle parameters, and/or the entity identity parameters.

4. The system of claim 3, wherein the adjustments to the composite representation include adjustments to the visual symbol and/or the values, wherein the one or more processors are further configured by the machine-readable instructions to:
receive a request to export the composite representation, wherein the visual symbol is updated upon determination of the adjustments to the composite representation.

5. The system of claim 4, wherein the visual symbol includes one of an image, a graphical image file, and a short video.

6. The system of claim 1, further comprising an electronic storage configured to store the correlated entities, wherein determining the correlated entities includes accessing the electronic storage.

7. The system of claim 1, wherein determining the set of digital assets, determining the correlated entities, and analyzing the correlated entities is performed periodically.

8. A method to generate a composite representation of a digital wallet based on digital assets indicated by the digital wallet, the method comprising:
determining a set of digital assets held in a digital wallet associated with a user, wherein the digital assets are correlated with entities, wherein digital wallets correspond to addresses on a decentralized ledger;
determining, based on the set of digital assets, the correlated entities;
analyzing the correlated entities to determine a composite representation of the entities or adjustments to the composite representation;
minting a composite digital asset correlated with the composite representation; and
updating, upon determination of the adjustments to the composite representation, the composite representation in accordance with the adjustments.

9. The method of claim 8, wherein the entities include a digital character, a digital tool, a digital media file, a digital location, and/or a digital vehicle, wherein individual ones of the entities are associated with values to ability parameters, battle parameters, entity identity parameters, and/or accomplishments.

10. The method of claim 9, wherein the composite representation includes a visual symbol and values to the ability parameters, the battle parameters, and/or the entity identity parameters.

11. The method of claim 10, wherein the adjustments to the composite representation include adjustments to the visual symbol and/or the values, further comprising:
receiving a request to export the composite representation, wherein the visual symbol is updated upon determination of the adjustments to the composite representation.

12. The method of claim 11, wherein the visual symbol includes one of an image, a graphical image file, and a short video.

13. The method of claim 8, further comprising storing, in an electronic storage, the correlated entities, wherein determining the correlated entities includes accessing the electronic storage.

14. The method of claim 8, wherein determining the set of digital assets, determining the correlated entities, and analyzing the correlated entities is performed periodically.
